(19) United States
(12) Patent Application Publication
(10) Pub. No.: US 2007/0166516 A1
(43) Pub. Date: Jul. 19, 2007

(54) FLOORING TILE PRODUCIBLE BY CONTINUOUS PROCESS AND HAVING THREE-DIMENSIONAL EFFECT, AND PROCESS FOR PREPARING THE SAME

(75) Inventors: Gyu-Yull Kim, Cheongju-si (KR); Chang-Hwan Park, Cheongju-si (KR); Chang-Il Kim, Cheongju-si (KR)

Correspondence Address: CANTOR COLBURN, LLP, 55 GRIFFIN ROAD SOUTH, BLOOMFIELD, CT, 06002, US

(73) Assignee: LG CHEM, LTD., Seoul (KR)

(21) Appl. No.: 11/549,736

(22) Filed: Oct. 16, 2006

(30) Foreign Application Priority Data
Jan. 18, 2006 (KR) 10-2006-0005176

(51) Int. Cl. B32B 3/00

(52) U.S. Cl. 428/172

(57) ABSTRACT

Disclosed are a flooring time including a substrate layer, printed layer, and transparent film, which are laminated from the bottom, and concave patterns mechanically embossed on the substrate layer and printed layer at the same time, and a process for preparing the flooring tile. The laminating and embossing operation of the respective layers are successively performed by use of a series of successively arranged rolls.

This application claims the benefit of the filing date of Korean Patent Application No. 10-2006-0005176 filed on Jan. 18, 2006 in the Korean Intellectual Property Office, the disclosure of which is incorporated herein in its entirety by reference.

### TECHNICAL FIELD

The present invention relates to a flooring tile having a three-dimensional pattern effect obtained by mechanically embossed patterns and a process for preparing the flooring tile, and more particularly, to a process for preparing a flooring tile in which laminating and embossing operations of layers are successively performed by a series of successively arranged rolls.

### BACKGROUND ART

Conventionally, vinyl chloride resin flooring tiles are provided therein with printed materials and embossed surface patterns, to realize a certain outer appearance thereof. However, the resulting outer appearance of the conventional flooring tiles is limited to only a planar expression.

Specifically, in the case of conventional flooring tiles having an outer appearance realized by a printed material, a gravure printing or rotary printing is first performed on a white vinyl chloride resin sheet layer, and then, a transparent vinyl chloride resin protective layer is coated on the printed layer, so as to express a variety of outer appearances based on the reality of the printed layer. This is a method for providing tiles with a three-dimensional outer-appearance effect using an illusion, such as a hologram, etc., and has a limit in the accomplishment of the three-dimensional outer-appearance effect.

Korean Utility Model Registration No. 153188 discloses a flooring having a three-dimensionally embossed pattern. Specifically, the disclosed flooring includes a plurality of resin layers each having a printed surface formed on a foam layer. The printed surface has a mechanically embossed portion formed by means of an embossing roll. At least one layer above the printed surface is formed with an embossed portion consisting of styrene resin beads, which have a crosslink structure obtained via suspension polymerization of styrene monomers. The foam layer has a chemically embossed portion formed by a foaming inhibitor. In the Korean Utility Model Registration as stated above, although it discloses the mechanically embossed portion of the flooring, it has no description about a method for forming the mechanically embossed portion, and the mechanically embossed portion has a different structure from that of the present invention.

The present inventors have already developed a vinyl chloride flooring tile wherein a printed material is laminated on a substrate layer, a concave embossed pattern is mechanically formed on both the printed material and substrate layer at the same time by a press roll, and a colored or transparent sol is filled in the mechanically embossed concave pattern. Although the flooring tile has a three-dimensional pattern effect by virtue of the printed material, mechanically embossed pattern, and colored or transparent sol, it has a problem of a complex process due to the fact the sol has to be coated on the mechanically embossed pattern.

To simplify the complex process, it was attempted to laminate a transparent film on the mechanically embossed pattern instead of the sol coating. However, this causes air bubbles during a laminating operation due to a space occupied by the mechanically embossed pattern, resulting in deterioration in the outer appearance and physical properties of the resulting tile product.

The above-described vinyl chloride flooring tile, moreover, has a problem in that it shows a very poor productivity of approximately 60 m²/hour.

### [Disclosure]

### [Technical Problem]

Therefore, the present invention has been made in view of the above problems, and it is an object of the present invention to provide a flooring tile capable of achieving a considerable improvement in the productivity thereof as well as outstanding three-dimensional pattern effect by mechanically embossed patterns, and a process for preparing the flooring tile.

It is another object of the present invention to provide a flooring tile capable of preventing generation of air bubbles during lamination, thereby eliminating the risk of deterioration in the outer appearance and physical properties thereof, and a process for preparing the flooring tile.

### [Technical Solution]

In accordance with an aspect of the present invention, the above and other objects can be accomplished by the provision of a flooring tile comprising a substrate layer, a printed layer, and a transparent layer laminated in this sequence from the bottom, wherein concave patterns are mechanically embossed on both the substrate layer and printed layer at the same time and the transparent layer is filled in the mechanically embossed concave patterns, whereby the flooring tile is provided with a three-dimensional pattern effect by the printed layer, mechanically embossed patterns, and transparent layer.

In the present invention, the transparent layer may be formed by coating transparent sol or colored sol. Preferably, the transparent layer may be stacked as a transparent film for improving productivity.

Preferably, the mechanically embossed patterns may be continuously connected to one another in a direction. With this configuration, it is possible to prevent deterioration in the outer appearance and physical properties of the tile caused by air bubbles.

To increase the reality of patterns, the transparent film may have an embossed upper surface. Also, to restrict the generation of air bubbles, the transparent film may have a lower surface formed with embo-pins.

In the flooring tile of the present invention, to achieve several advantages, such as the leveling of a floor, reinforced reality of patterns, and improved physical properties of a tile surface, a balance sheet may be laminated at a lower surface of the substrate layer, and a surface finishing layer may be laminated at an upper surface of the transparent layer, in addition to the embossed upper surface of the transparent film.

In accordance with another aspect of the present invention, the above and other objects can be accomplished by the provision of a process for preparing a flooring tile comprising a balance sheet, a substrate layer, a printed layer, and a transparent film laminated in this sequence from the bottom, concave patterns being mechanically embossed on both the substrate layer and printed layer at the same time, wherein laminating and embossing operations of the respective layers are successively performed by use of a series of successively arranged rolls.

In accordance with a first embodiment of the present invention, the process may comprise: producing the balance sheet, the substrate layer, a white printing sheet, and the transparent film; laminating the balance sheet, substrate layer, and white printing sheet in this sequence from the bottom by use of a first laminating roll; forming the printed layer by performing a transcription printing operation on the white printing sheet by use of a transcription printing roll; mechanically embossing patterns on the substrate layer and printed layer by use of a mechanical embossing roll; and laminating the transparent film on the printed layer by use of a second laminating roll.

In accordance with a second embodiment of the present invention, the process may comprise: producing the balance sheet, substrate layer, printed layer, and transparent film; laminating the balance sheet, printed layer, and substrate layer in this sequence from the bottom while mechanically embossing patterns on the printed layer and substrate layer by use of a mechanical embossing roll; and laminating the transparent film on the printed layer by use of a second laminating roll.

Preferably, the mechanical embossing roll may have embossed convex patterns, which are continuously connected to one another in an advancing direction of the tile. This has the effect of preventing the generation of air bubbles when the transparent film is thermally laminated on the mechanically embossed patterns.

Preferably, the process may further comprise: forming an embossed surface portion at an upper surface of the transparent film by use of a surface embossing roll; and forming a surface finishing layer on the embossed surface portion. This has the effect of reinforcing the reality of patterns and overcoming the risk of contamination of the tile when initially used.

In consideration of printing characteristics, the printed layer may be formed by use of a semi-hard white sheet containing 100 parts by weight of a base resin and 10˜50 parts by weight of a plasticizer. Also, to maximize a three-dimensional pattern effect, preferably, the white sheet may be subjected partially or wholly to a primary printing using pearl ink or silver powder, and a secondary printing using conventional inks on the primarily printed sheet.

The mechanically embossed patterns may have a depth of 0.05˜0.9 mm and each pattern may contain doubly and triply angled portions in a longitudinal cross section, to maximize a three-dimensional pattern effect.

As stated above, the present invention has a feature in that mechanically embossed patterns are formed at surfaces of both a printed layer and substrate layer so that they are successively connected to one another, a transparent film having a predetermined thickness is laminated on the printed layer to provide the tile with a durability, and an embossed surface portion and surface finishing layer are provided on the transparent film to maximize a three-dimensional pattern effect. In particular, the present invention employs a successive tile preparation process, to achieve a remarkable improvement in the productivity of the flooring tile.

### DESCRIPTION OF DRAWINGS

The above and other objects, features and other advantages of the present invention will be more clearly understood from the following detailed description taken in conjunction with the accompanying drawings, in which:

FIG. 1 is a sectional view illustrating a press roll having predetermined patterns for providing a tile with mechanically embossed patterns according to an embodiment of the present invention;

FIG. 2 is a plan view of the press roll of FIG. 1;

FIG. 3 is a plan view illustrating a press roll having predetermined patterns for providing a tile with mechanically embossed patterns according to another embodiment of the present invention;

FIG. 4 is a sectional view illustrating a semi-finished tile material including a printed layer, a substrate layer, and a balance sheet, which are adhered to one another in this sequence from the top;

FIG. 5 is a sectional view of the tile material of FIG. 4, on which embossed patterns are mechanically formed by use of a press roll having predetermined patterns;

FIG. 6 is a sectional view of the tile material of FIG. 5, on which a transparent film is laminated in a successive process;

FIG. 7 is a sectional view of a finished flooring tile product obtained by performing surface embossing and finishing treatments on the tile material of FIG. 6;

FIG. 8 is a process view of a successive tile preparation sequence according to a first embodiment of the present invention; and

FIG. 9 is a process view of a successive tile preparation sequence according to a second embodiment of the present invention.

### DESCRIPTION OF REFERENCE NUMERALS TO IMPORTANT PARTS OF THE DRAWINGS

| | |
|---|---|
| 1: substrate layer | 2: printed layer |
| 2a: white sheet | 2b: transcription printing film |
| 3: balance sheet | 4: mechanically embossed pattern |
| 5: transparent film | 6: surface finishing layer |
| 7: embossed surface portion | 10: first laminating roll |
| 20: transcription printing roll | 30: mechanical embossing roll |
| 40: second laminating roll | 50: surface embossing roll |

### [Best Mode]

Now, the present invention will be described in detail with reference to the accompanying drawings.

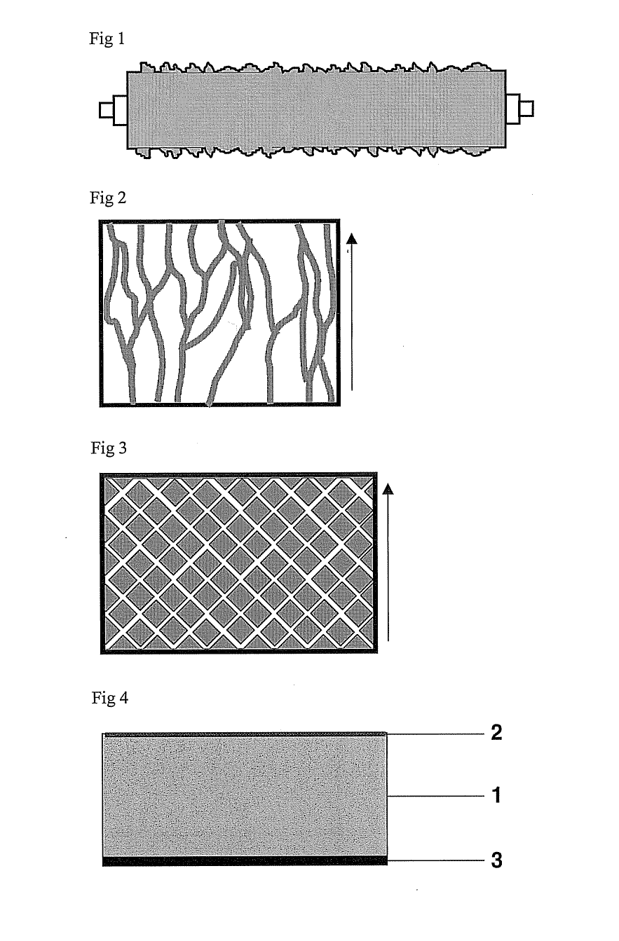

FIG. 1 is a sectional view of a press roll required to realize three-dimensional patterns according to the present invention, and FIGS. 2 and 3 are plan views of different examples of the press roll having regular patterns or irregular patterns. It should be understood that the patterns shown in the drawings are given only for the purpose of exemplification and any other patterns are usable.

The press roll has embossed patterns to provide a printed layer of a tile with mechanically embossed patterns. In FIGS. 2 and 3, the arrows denote an advancing direction of a tile material and preferably, the patterns of the press roll are connected to one another continuously in the advancing direction of the tile material.

To guarantee efficient preparation of a flooring tile based on a successive process according to the present invention, the mechanically embossed patterns provided by the press roll must be connected to one another if possible in the advancing direction of the tile material in consideration of the fact that the tile is prepared via a successive process.

If the mechanically embossed patterns are not connected to one another in the advancing direction of the tile material, it may often cause air bubbles at discontinuous joining portions between the patterns while a transparent film is compressively laminated on the tile material formed with the mechanically embossed patterns, resulting in production of defective products.

Preferably, the patterns of the press roll are configured to have double or triple angled portions in the same pattern to maximize a three-dimensional pattern effect. In this case, a length of embossed convex portions formed in the press roll or embossing plate capable of providing the tile material with patterns may be 0.05˜0.9 mm, and this length range is suitable to maximize a three-dimensional pattern effect.

FIG. 4 is a sectional view of the tile material including a substrate layer 1, and a printed layer 2 and a balance sheet 3 laminated above and below the substrate layer 1, respectively.

The substrate layer 1 is a vinyl chloride resin layer formed of a sheet obtained by blending a vinyl chloride resin, plasticizer, stabilizer, and calcium carbonate as main components, and performing banbury mixer kneading, mixing, pre-heating, and calendering on the blend to have a predetermined thickness. Here, the allowable maximum amount of calcium carbonate is 50˜500 parts by weight on the basis of 100 parts by weight of vinyl chloride resin. Alternatively, the substrate layer 1 may take the form of a chip layer consisting of a plurality of chips.

The printed layer 2 is made of a semi-hard white sheet containing 100 parts by weight of a base resin and 10˜50 parts by weight of a plasticizer in consideration of printing characteristics. Also, to maximize a three-dimensional pattern effect, the semi-hard white sheet may be partially or wholly subjected to a primary printing process using pearl ink and/or silver powder. After being dried, subsequently, the primarily printed sheet is again subjected to a secondary printing process using conventional inks.

The primary printing of the semi-hard sheet using the pearl ink or silver powder is advantageous to maximize dispersion and scattered reflection of light, so as to accomplish a desired three-dimensional pattern effect. With the use of the printed layer 2, it is possible to obtain any kinds of printed patterns applicable to marble, wood, and other amorphous materials.

The balance sheet 3 is a vinyl chloride resin sheet obtained by blending a vinyl chloride resin, plasticizer, stabilizer, and calcium carbonate as main components, and performing banbury mixer kneading, mixing, pre-heating, and calendering on the blend to have a predetermined thickness.

The printed layer 2, substrate layer 1, and balance sheet 3 are integrated to one another via a thermal laminating operation, to thereby form a semi-finished tile material. A total thickness of the tile material is adjustable based on a thickness of the substrate layer 1.

Although not shown, a dimension-reinforcing layer may be inserted into the substrate layer 1 for the sake of a reinforced stable dimension of the resulting flooring tile. The dimension-reinforcing layer is a glass fiber or non-woven fabric layer, and is inserted in a middle portion of the substrate layer 1, so as to prevent generation of cracks in use of the flooring tile and consequently, achieve a dimensional stability of the flooring tile.

FIG. 5 is a sectional view of the tile material of FIG. 4, on which embossed patterns 4 are mechanically formed by use of a press roll having predetermined patterns.

If the semi-finished tile material, including the printed layer 2 laminated on the substrate layer 1, is compressed by the press roll having the predetermined patterns (See FIGS. 1 to 3), the patterns of the press roll are transferred to the printed layer 2 and substrate layer 1, thereby leaving mechanically embossed patterns 4 on both the layers. In this case, to maximize a three-dimensional pattern effect while preventing generation of air bubbles, as shown in FIGS. 1 to 3, it is preferable that the resulting patterns are continuously connected to one another in the advancing direction of the tile material and each pattern includes double or triple angled portions.

By compressing the tile material with the press roll having embossed convex patterns, the tile material includes the mechanically embossed concave patterns 4 formed in the substrate layer 1 as well as the printed layer 2.

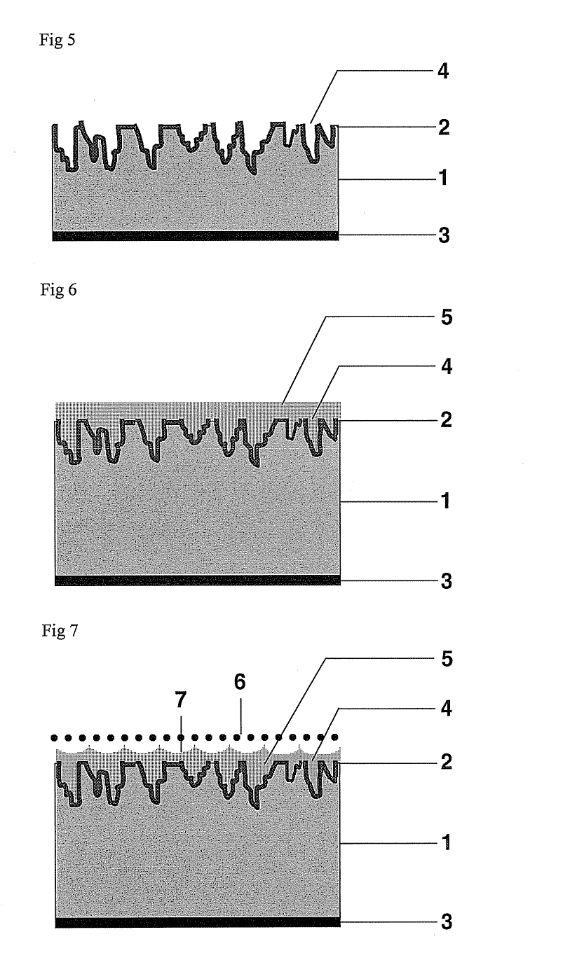

FIG. 6 is a sectional view of the tile material of FIG. 5, on which a transparent film 5 is laminated on an upper surface of the tile material in a successive process. When the transparent film 5 is thermally laminated on the mechanically embossed patterns 4 of the tile material for increasing the durability of a product surface, a flooring tile having a three-dimensional pattern effect can be prepared.

The transparent film 5 for increasing the durability of product surface is obtained by blending a vinyl chloride resin, plasticizer and stabilizer, performing banbury mixer kneading, mixing, pre-heating, and calendering on the blend to have a predetermined thickness.

To prevent generation of air bubbles, alternatively, the transparent film 5 may be formed at a lower surface thereof with a plurality of embo-pins resembling a pear's skin. However, when the mechanically embossed patterns 4 are continuously connected to one another in the advancing direction of the tile according to the present invention, the generation of air bubbles can be sufficiently restricted without using the embo-pins.

FIG. 7 is a sectional view of a finished flooring tile product obtained by providing the tile of FIG. 6 with an embossed surface portion 7 and a surface finishing layer 6.

The surface finishing layer 6 is formed by coating a paint containing polyurethane as a main component, and serves to restrict the contamination of a product when initially used, thereby achieving an improvement in the anti-contamination properties of the product.

The embossed surface portion 7 is formed on the transparent film 5 to reinforce the reality of the patterns 4.

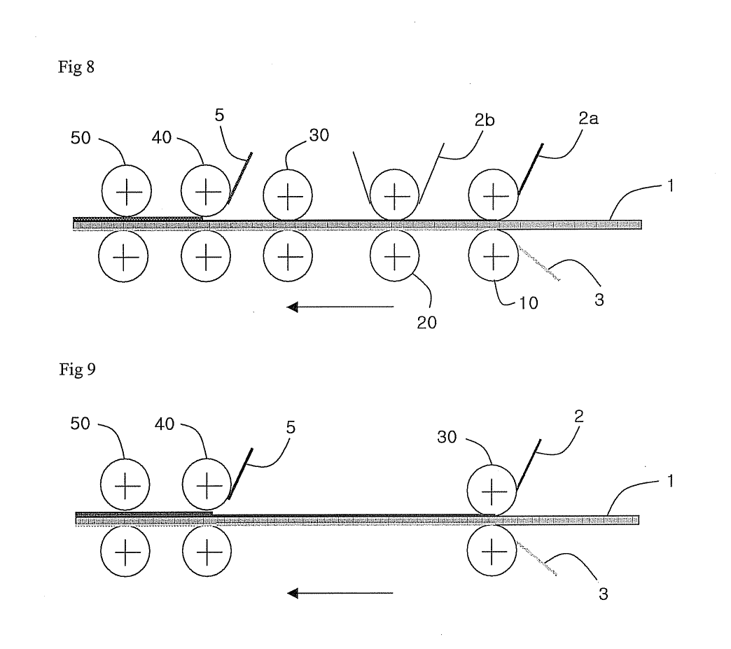

FIG. 8 is a process view illustrating a successive tile preparation process according to a first embodiment of the present invention. The arrow in FIG. 8 represents the advancing direction of the tile material.

First, the balance sheet 3, substrate layer 1, white printing sheet 2a, and transparent film 5 are prepared, respectively.

Next, the balance sheet 3, substrate layer 1, and white printing sheet 2a are laminated in this sequence from the bottom by use of a first laminating roll 10.

Then, a transcription printing film 2b is printed on the white printing sheet 2a of the laminated tile material by use of a transcription printing roll 20, to form the printed layer 2. In this case, the transcription printing film 2b may be a polyethylene terephthalate (PET) film, or the like.

Subsequently, the mechanically embossed patterns 4 are formed on both the printed layer 2 and substrate layer 1 by use of a mechanical embossing roll 30.

Next, the transparent film 5 is laminated on the printed layer 2 having the mechanically embossed patterns 4 by use of a second laminating roll 40.

Thereafter, the embossed surface portion 7 is formed on the transparent film 5 by use of a surface embossing roll 50.

Finally, the surface finishing layer 6 is formed on an uppermost surface of the tile material having the embossed surface portion 7, to complete a flooring tile product according to the present invention.

FIG. 9 is a process view illustrating a successive tile preparation process according to a second embodiment of the present invention. Compared with the process of FIG. 8, in the process of the present embodiment, the transcription printing roll 20 is omitted and the mechanical embossing roll 30 has the role of the first laminating roll 10.

First, the balance sheet 3, substrate layer 1, printed layer 2, and transparent film 5 are prepared, respectively. In this case, the printed layer 2 is previously prepared, and can be formed by use of both a transcription PET and printing material. In the cases where pearl ink or silver powder is directly printed on a transcription PET or white sheet, the printing position of the pearl ink or silver power is reversed. In both the cases, conventional inks will come into direct contact with the transparent film 5.

Next, the balance sheet 3, substrate layer 1, and printed layer 2 are laminated in this sequence from the bottom by use of the mechanical embossing roll 30. Simultaneously with the laminating operation, the patterns 4 are mechanically embossed on the substrate layer 1 as well as printed layer 2. In this case, the mechanical embossing roll 30 also performs the role of the first laminating roll 10 shown in FIG. 8.

The following procedure is equal to that of FIG. 8.

### EXAMPLE 1

The white printing sheet 2a was produced by kneading 100 parts by weight of a vinyl chloride resin having a polymerizing degree of 800˜1300, 30 parts by weight of dioctylphthalate as a plasticizer, 4 parts by weight of a barium-zinc compound as a heat stabilizer, 3 parts by weight of an epoxy resin for reinforcing a long-term low-temperature heat resistance property, 15 parts by weight of titanium dioxide as a pigment, and 30 parts by weight of calcium carbonate as a filler with a banbury mixer, and rolling a heated soft compound with a calender having a temperature of 170° C. to have a thickness of 0.1 mm.

Then, the transparent film 5 was produced by kneading 100 parts by weight of a vinyl chloride resin having a polymerizing degree of 1000˜1300, 35 parts by weight of dioctylphthalate, 3 parts by weight of a barium-zinc compound, and 3 parts by weight of an epoxy resin with a banbury mixer, and rolling a heated soft compound with a calender having a temperature of 170° C. to have a thickness of 0.5 mm.

Subsequently, the balance sheet 3 was produced by kneading 100 parts by weight of a vinyl chloride resin having a polymerizing degree of 800˜1300, 30 parts by weight of dioctylphthalate, 3 parts by weight of a barium-zinc compound, 3 parts by weight of an epoxy resin, and 60 parts by weight of calcium carbonate with a banbury mixer, and rolling a heated soft compound with a calender having a temperature of 170° C. to have a thickness of 0.65 mm.

Also, the substrate layer 1 was produced by kneading 100 parts by weight of a vinyl chloride resin having a polymerizing degree of 800˜1300, 40 parts by weight of dioctylphthalate, 3 parts by weight of a barium-zinc compound, 3 parts by weight of an epoxy resin, and 300 parts by weight of calcium carbonate with a banbury mixer, and rolling a heated soft compound with a calender having a temperature of 170° C. to have a thickness of 1.85 mm.

Thereafter, to manufacture a tile material in the successive preparation process of FIG. 8, the white sheet 2a and balance sheet 3 were laminated at opposite sides of the substrate layer 1 by use of the first laminating roll 10 by applying a pressure of approximately 5 kg/cm², to thereby manufacture the tile material having a configuration as shown in FIG. 4. In this, case, a temperature of the tile material was approximately 145° C.

Subsequently, the transcription printing material 2b, such as a PET material, was printed on the white sheet 2a by use of the transcription printing roll 20, to form the printed layer 2. In this case, the transcription PET film 2b has a marble pattern, and a lower surface of the film 2b coming into contact with the white sheet was primarily printed by use of pearl ink.

After completing the printing operation, the tile material was formed with the mechanically embossed patterns 4 by use of the mechanical embossing roll 30. In this case, a patterning pressure was set at approximately 5 kg/cm², and a temperature of the tile material was approximately 120° C. In this way, the tile material having a configuration as shown in FIG. 5 was obtained.

Next, the transparent film 5 is laminated on the tile material formed with the mechanically embossed patterns 4 by use of a latent heat of the tile material (120° C.) under operation of the second laminating roll 40, to obtain the tile material having a configuration as shown in FIG. 6.

Thereafter, the resulting tile material was pre-heated at a temperature of approximately 150° C., and the embossed surface portion 7 was formed by use of the surface embossing roll 50.

Finally, after forming the surface finishing layer 6 via a surface treatment, the tile material was cut to a desired size, to complete a vinyl chloride resin tile as shown in FIG. 7, which is obtained via a successive tile preparation process and has a three-dimensional pattern effect.

### EXAMPLE 2

In the same manner as that of the above described Example 1, the substrate layer 1, balance sheet 3, and transparent film 5 were manufactured.

The printed layer 2 was previously manufactured. Specifically, pearl ink was primarily printed on a part of the white sheet 2a that was manufactured in the same manner as that of the Example 1, and then, a marble pattern was secondarily printed on the resulting printed sheet by use of a gravure printer, to manufacture the printed layer 2.

Then, to manufacture a tile material in the successive preparation process of FIG. 9, the printed layer 2 and balance sheet 3 were laminated at opposite sides of the substrate layer 1 at a pressure of 5 kg/cm² by use of the mechanical embossing roll 30 simultaneously while forming the mechanically embossed patterns 4 on the substrate layer 1 and printed layer 2, to thereby manufacture the tile material having a configuration as shown in FIG. 5.

The following procedure is equal to that of the Example 1.

### COMPARATIVE EXAMPLE

A vinyl chloride resin flooring tile having a configuration as shown in FIG. 7 was manufactured via a press method.

### TEST EXAMPLE

The following Table 1 compares the productivities of the flooring tiles prepared based on the above described Example 1 and Comparative Example. As can be confirmed from the Table 1, the flooring tile obtained by the successive tile preparation process of the present invention has a considerable improvement in productivity.

TABLE 1

| | Example 1 | Comparative Example |
|---|---|---|
| Productivity | 992 m²/hour | 60 m²/hour |

### INDUSTRIAL APPLICABILITY

As apparent from the above description, the present invention provides a flooring tile having a three-dimensional pattern effect obtained by mechanically embossed patterns, which can be manufactured by successively performing laminating and embossing operations of layers by use of a series of successively arranged rolls, thereby achieving a considerable improvement in the productivity of flooring tiles.

Further, according to the present invention, the mechanically embossed patterns are continuously connected to one another in an advancing direction of a tile material. This has the effect of preventing generation of air bubbles in the course of laminating a transparent film on the mechanically embossed patterns without a separate operation.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A flooring tile comprising a substrate layer, a printed layer, and a transparent layer laminated in this sequence from the bottom,
wherein mechanically embossed concave patterns are formed on both the substrate layer and the printed layer at the same time and the transparent layer is filled in the mechanically embossed concave patterns,
whereby the flooring tile is provided with a three-dimensional pattern effect.

2. The flooring tile according to claim 1, wherein the transparent layer is a transparent film.

3. The flooring tile according to claim 1, wherein the mechanically embossed patterns are continuously connected to one another in a direction.

4. The flooring tile according to claim 1, wherein the mechanically embossed patterns have a depth of 0.05˜0.9 mm and each pattern includes double and triple angled portions in a longitudinal cross section.

5. The flooring tile according to claim 2, wherein the transparent film has an embossed upper surface.

6. The flooring tile according to claim 2, wherein the transparent film has a lower surface formed with embo-pins.

7. The flooring tile according to claim 1, wherein a balance sheet is laminated at a lower surface of the substrate layer, and a surface finishing layer is laminated at an upper surface of the transparent layer.

8. The flooring tile according to claim 1, wherein the printed layer is formed by performing a primary printing using pearl ink or silver powder on a part of or throughout a semi-hard white sheet containing 100 parts by weight of a base resin and 10˜50 parts by weight of a plasticizer, and performing a secondary printing using conventional inks on the primarily printed sheet.

9. A process for preparing a flooring tile comprising a substrate layer, a printed layer, and a transparent film laminated in this sequence from the bottom, with concave patterns mechanically embossed on both the substrate layer and the printed layer at the same time,
wherein laminating and embossing of each layer are successively performed by use of a series of successively arranged rolls.

10. The process according to claim 9, comprising:
producing the substrate layer, a white printing sheet, and the transparent film;
laminating the white printing sheet on the substrate layer by use of a first laminating roll;
performing a transcription printing on the white printing sheet by use of a transcription printing roll to form the printed layer;
forming mechanically embossed patterns on the substrate layer and the printed layer by use of a mechanical embossing roll; and
laminating the transparent film on the printed layer by use of a second laminating roll.

11. The process according to claim 9, comprising:
producing the substrate layer, the printed layer, and the transparent film;
laminating the printed layer on the substrate layer while forming mechanically embossed patterns on the printed layer and the substrate layer by use of a mechanical embossing roll; and
laminating the transparent film on the printed layer by use of a second laminating roll.

12. The process according to claim 10, wherein the mechanical embossing roll has embossed convex patterns, which are continuously connected to one another in an advancing direction of the tile.

13. The process according to claim 11, wherein the mechanical embossing roll has embossed convex patterns, which are continuously connected to one another in an advancing direction of the tile.

14. The process according to claim 10, further comprising:
forming an embossed surface portion at an upper surface of the transparent film by use of a surface embossing roll, and subsequently, forming a surface finishing layer on the embossed surface portion; and
laminating a balance sheet at a lower surface of the substrate layer.

15. The process according to claim 11, further comprising:
forming an embossed surface portion at an upper surface of the transparent film by use of a surface embossing roll, and subsequently, forming a surface finishing layer on the embossed surface portion; and
laminating a balance sheet at a lower surface of the substrate layer.
